(19) United States
(12) Patent Application Publication
(10) Pub. No.: US 2014/0053284 A1
(43) Pub. Date: Feb. 20, 2014

(54) DATA TRANSMISSION DEVICE AND METHOD FOR AGGREGATING MEDIA CONTENT FROM A CONTENT PROVIDER

(71) Applicants: Jin Hong Yang, Daejeon (KR); Hyo Jin Park, Daejeon (KR); Jun Kyun Choi, Daejeon (KR); Hong Shik Park, Daejeon (KR)

(72) Inventors: Jin Hong Yang, Daejeon (KR); Hyo Jin Park, Daejeon (KR); Jun Kyun Choi, Daejeon (KR); Hong Shik Park, Daejeon (KR)

(73) Assignee: Intellectual Discovery Co., Ltd., Seoul (KR)

(21) Appl. No.: 14/113,477

(22) PCT Filed: Apr. 19, 2012
(86) PCT No.: PCT/KR2012/003018

§ 371 Date: Oct. 23, 2013

(30) Foreign Application Priority Data
Apr. 25, 2011 (KR) 10-2011-0038538

(51) Int. Cl. G06F 21/60

(52) U.S. Cl. CPC G06F 21/606
USPC 726/30; 709/217

(57) ABSTRACT

Disclosed are a data transmission device and method. The data transmission device may comprise: a content aggregating unit for aggregating content relating to data from a content provider; a content preparing unit for preparing the aggregated content; and a content providing unit for providing the prepared content to a client.

### TECHNICAL FIELD

The present invention relates to a data transmission device and method for aggregating content, and more particularly, to a method and device for aggregating content to be provided to a client, from a content provider (CP).

### BACKGROUND ART

In a case of media such as an internet protocol television (IPTV) and a smart TV, ensuring content or service is a main issue. However, separately producing the content or the service for exclusive use in the media may require a significant effort and incur high costs.

In a network widely known to date, such as the Internet, a variety of contents and services are provided. Initially, production of the provided contents and the services is not intended for use in the media such as the IPTV and the smart TV. As such, a method of effectively ensuring the contents or the services is necessary because a content provider or a service provider providing the contents or the services performs provision using a separate provision method.

The contents provided in a network are sufficiently suitable for being applied to the media such as the IPTV or the smart TV. Accordingly, there is a need for a method of effectively aggregating the contents and using the aggregated contents.

### DISCLOSURE OF INVENTION

### Technical Goals

An aspect of the present invention provides a method and device for effectively aggregating content from a content provider and providing the aggregated content to a client.

Another aspect of the present invention also provides a method and device for aggregating content from a content provider in a contractual relationship and stably providing the aggregated content to a client.

### Technical Solutions

According to an aspect of the present invention, there is provided a data transmission device including a content aggregating unit to aggregate content associated with data from a content provider (CP), a content preparing unit to prepare the aggregated content, and a content providing unit to provide the prepared content to a client.

The content aggregating unit may aggregate content from a CP registered according to a contract process based on an authentication.

The content aggregating unit may aggregate content using a feed associated with metadata of the content.

The content aggregating unit may aggregate content based on a key which has a right to update metadata of the content.

The content aggregating unit may aggregate content by comparing metadata associated with digital rights management (DRM) of the content to metadata associated with an author of the content.

The data transmission device may further include a function module managing unit including a service information exposure module to perform functions of the content aggregating unit, a service enabler module to perform functions of the content preparing unit, and a network abstraction module to perform functions of the content providing unit.

According to another aspect of the present invention, there is also provided a data transmission device including a content aggregating unit to aggregate content associated with data from a CP, a content preparing unit to prepare the aggregated content, a content providing unit to provide the prepared content to a client, and a function module managing unit to manage the content aggregating unit, the content preparing unit, and the content providing unit.

The content aggregating unit may aggregate content using a feed associated with metadata of the content.

The function module managing unit may include a service information exposure module to perform functions of the content aggregating unit, a service enabler module to perform functions of the content preparing unit, and a network abstraction module to perform functions of the content providing unit.

The function module managing unit may manage based on a capability for operation, administration, maintenance, and provisioning (OAM&P) including at least one of a capability for authentication, authorization and accounting (AAA), a capability for access control, a capability for policy enforcement, and a capability for monitoring.

According to still another aspect of the present invention, there is also provided a data transmission method including aggregating, by a content aggregating unit, content associated with data from a CP, preparing, by a content preparing unit, the aggregated content, and providing, by a content providing unit, the prepared content to a client.

The aggregating may include aggregating content using a feed associated with metadata of the content.

The aggregating may include aggregating content based on a key which has a right to update metadata of the content.

According to yet another aspect of the present invention, there is also provided a data transmission method including managing, by a CP registration unit, a CP through registration, aggregating, by a content aggregating unit, content associated with data from the CP, preparing, by a content preparing unit, the aggregated content, and providing, by a content providing unit, the prepared content to a client, wherein a function module managing unit manages the content aggregating unit, the content preparing unit, and the content providing unit.

According to further another aspect of the present invention, there is also provided a data transmission method including aggregating, by a content aggregating unit, content associated with data from a CP, preparing, by a content preparing unit, the aggregated content, and providing, by a content providing unit, the prepared content to a client, wherein a function module managing unit manages the content aggregating unit, the content preparing unit, and the content providing unit.

### Advantageous Effects

According to an embodiment of the present invention, it is possible to effectively aggregate content from a content provider and providing the aggregated content to a client.

According to another embodiment of the present invention, it is also possible to aggregate content from a content provider in a contractual relationship and stably providing the aggregated content to a client.

### BRIEF DESCRIPTION OF DRAWINGS

FIG. 1 illustrates a configuration of a data transmission device according to an example embodiment of the present invention.

FIG. 2 is a diagram illustrating the data transmission device of FIG. 1 for each function module.

FIG. 3 is a diagram illustrating the data transmission device of FIG. 2.

FIG. 4 is a diagram illustrating a process of issuing an application programming interface (API) key to a content provider.

FIG. 5 is a diagram illustrating a process of aggregating metadata using a feed according to an example embodiment of the present invention.

FIG. 6 is a diagram illustrating a process of uploading content according to an example embodiment of the present invention.

FIG. 7 is a diagram illustrating a process of examining a copyright of content according to an example embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

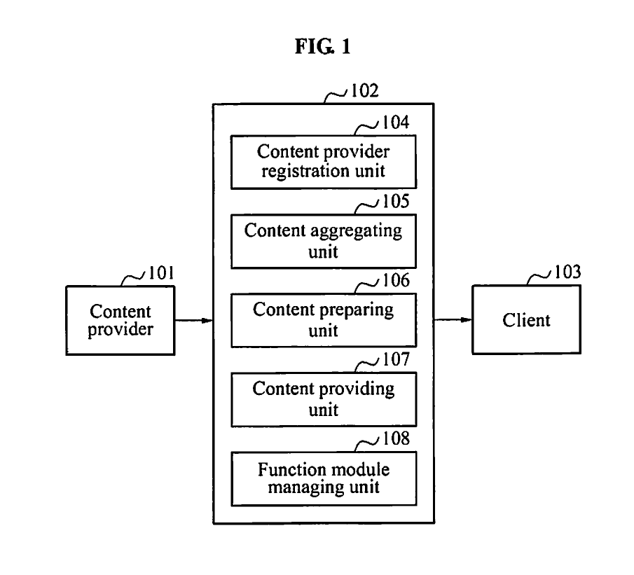

FIG. 1 illustrates a configuration of a data transmission device according to an example embodiment of the present invention.

Referring to FIG. 1, a data transmission device 102 may include a content provider registration unit 104, a content aggregating unit 105, a content preparing unit 106, a content providing unit 107, and a function module managing unit 108.

The content provider registration unit 104 may register a content provider 101 including content. For example, the content provider registration unit 104 may register the content provider 101 according to a contract process based on an authentication. Although only the content provider 101 is described herein, the same description may be applied identically to a service provider.

The content aggregating unit 105 may aggregate content associated with data from the content provider 101. For example, the content aggregating unit 105 may aggregate content using a feed associated with metadata of the content. In this example, the content aggregating unit 105 may aggregate the content based on a key which has a right to update metadata of the content.

Also, the content aggregating unit 105 may examine a copyright of the content. In particular, the content aggregating unit 105 may aggregate the content by comparing metadata associated with digital rights management (DRM) of the content to metadata associated with an author of the content. Hereinafter, a process of aggregating content will be described in detail.

The content preparing unit 106 may prepare the content aggregated by the content aggregating unit 105. Here, preparing content may refer to preparing metadata of the content to provide the content.

The content providing unit 107 may provide the content prepared by the content preparing unit 106 to a client.

The function module managing unit 108 may manage and/or control the content aggregating unit 105, the content preparing unit 106, and the content providing unit 107 to be performed. For example, the function module managing unit 108 may include a service information exposure module to perform functions of the content aggregating unit 105, a service enabler module to perform functions of the content preparing unit 106, and a network abstraction module to perform functions of the content providing unit 107.

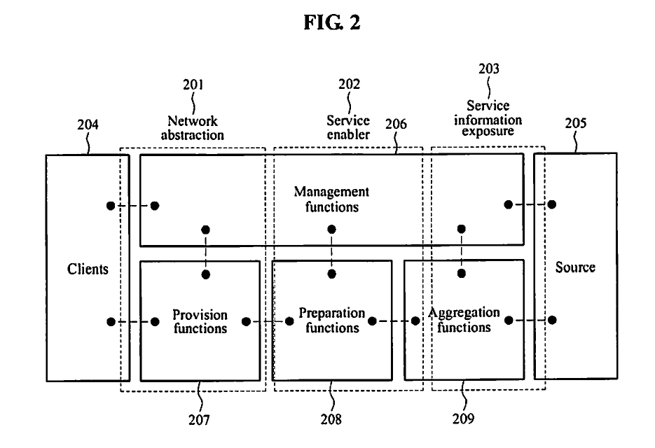

FIG. 2 is a diagram illustrating the data transmission device 102 of FIG. 1 for each function module.

Referring to FIG. 2, the data transmission device 102 may be divided for each function module. For example, the data transmission device 102 may be divided into management functions module 206, aggregation functions module 209, preparation functions module 208, and provision functions module 207. Sources 205 may indicate a subject possessing content and service. Clients 204 may indicate a subject provided with the content and the service from the sources 205.

Here, the aggregation functions module 209 may correspond to the content aggregating unit 105 of the data transmission device 102, the preparing functions module 208 may correspond to the content preparing unit 106 of the data transmission device 102, and the provision functions module 207 may correspond to the content providing unit 107 of the data transmission device 102.

The aggregation functions module 209 may receive the content or the service associated with data from the sources 205, thereby performing aggregation on the content or the service. The preparation functions module 208 may perform extraction, meditation, and composition on the content or the service associated with the data, thereby indexing and organizing the content or the service. The provision functions module 207 may provide the clients 204 with the content or the service associated with the data.

The aggregation functions module 209 and the management functions module 206 managing the aggregation functions module 209 may be included in a service information exposure module 203. The preparation functions module 208 and the management functions module 206 managing the preparation functions module 208 may be included in a service enabler module 202. The provision functions module 207 and the management functions module 206 managing the provision functions module 207 may be included in a network abstraction module 201

The management functions module 206 may manage the aggregation functions module 209, the preparation functions module 208, and the provision functions module 207 based on a capability for operation, administration, maintenance, and provisioning (OAM&P) including at least one of a capability for authentication, authorization, and accounting (AAA), a capability for access control, and a capability for monitoring for the data transmission device 102.

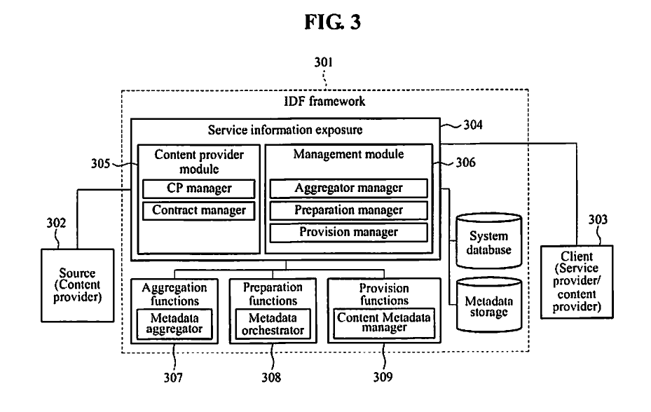

FIG. 3 is a diagram illustrating the data transmission device of FIG. 2.

Referring to FIG. 3, a service information exposure module 304 may correspond to the management functions module 206 of FIG. 2 and include a content provider module 305 and a management module 306. The content provider module 305 may include a CP manager managing a registered CP and a contract manager performing registration through a contract with the CP.

The management module 306 may include an aggregator manager to manage an aggregation functions module 307, a preparation manger to manage a preparation functions module 308, and a provision manager to manage a provision functions module 309.

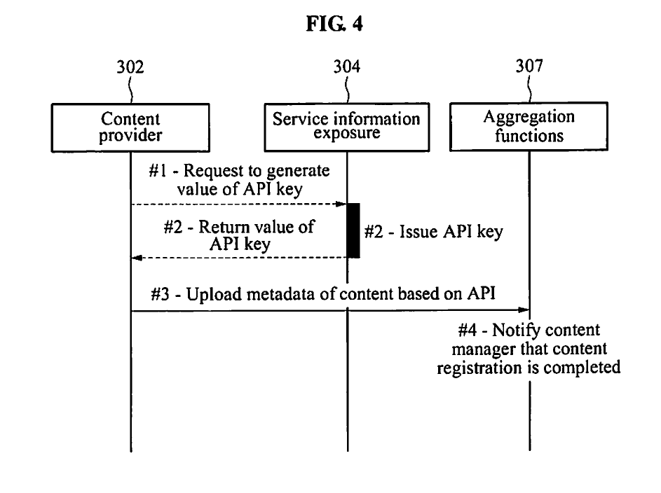

FIG. 4 is a diagram illustrating a process of issuing an application programming interface (API) key to a CP.

A CP 302 may request the service information exposure module 304 to generate a value of an API key. In response to the request, the service information exposure 304 may issue the value of the API key and return the value of the API key to the CP 302. The CP 302 may upload metadata of content to the aggregation functions module 307 based on the value of the API key and the API key including the metadata of the content. The aggregation functions module 307 may notify a content manager that content registration is completed. The value of the API key may include a hash value including internal information and registration information of the CP 302.

The CP 302 may request the service information exposure module 304 to apply for an admission of service providing the content. A request for a service admission may include a business registration number, information on a place of business, a form of content, an update cycle, a content production cycle, genre information, and the like. When the request for a service admission is admitted by the service information exposure module 304, the CP 302 may register profile information on a page.

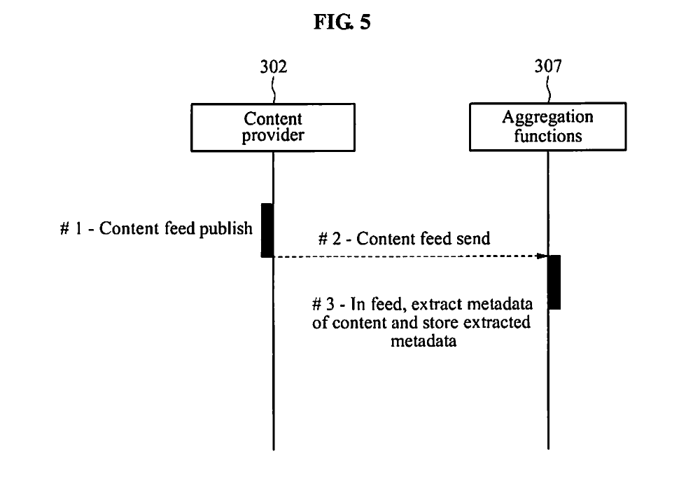

FIG. 5 is a diagram illustrating a process of aggregating metadata using a feed according to an example embodiment of the present invention.

The CP 302 may publish a feed of content and transmit the feed of content to the aggregation functions module 307. The aggregation functions module 307 may extract metadata of content and store the extracted metadata.

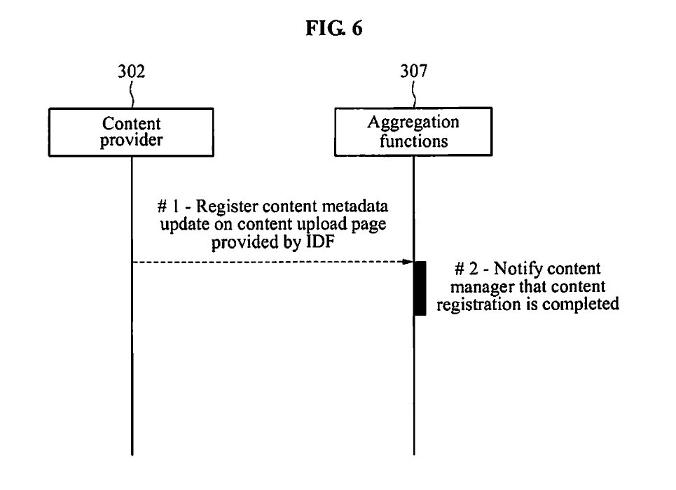

FIG. 6 is a diagram illustrating a process of uploading content according to an example embodiment of the present invention.

The CP 302 may register metadata of web format associated with content on a content upload page provided by the data transmission device. The aggregation functions module 307 may notify a content manager that content registration is completed.

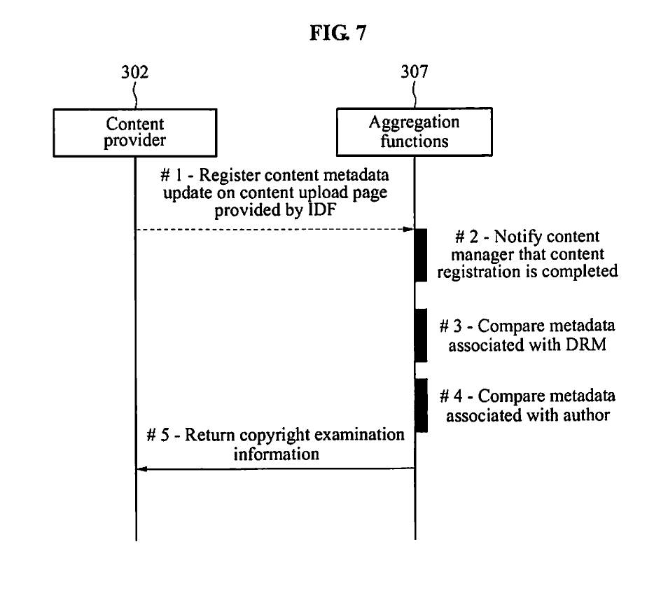

FIG. 7 is a diagram illustrating a process of examining a copyright of content according to an example embodiment of the present invention.

The CP 302 may register metadata of web format associated with content on a content upload page provided by the data transmission device. The aggregation functions module 307 may notify a content manager that content registration is completed. The aggregation functions module 307 may compare metadata associated with DRM and metadata associated with an author of the content to examine a copyright of the content. Also, the aggregation functions module 307 may return copyright examination information of the content to the CP 302.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A data transmission device comprising:
a content aggregating unit to aggregate content associated with data from a content provider (CP);
a content preparing unit to prepare the aggregated content; and
a content providing unit to provide the prepared content to a client.

2. The device of claim 1, wherein the content aggregating unit aggregates content from a CP registered according to a contract process based on an authentication.

3. The device of claim 1, wherein the content aggregating unit aggregates content using a feed associated with metadata of the content.

4. The device of claim 1, wherein the content aggregating unit aggregates content based on a key which has a right to update metadata of the content.

5. The device of claim 1, wherein the content aggregating unit aggregates content by comparing metadata associated with digital rights management (DRM) of the content to metadata associated with an author of the content.

6. The device of claim 1, further comprising:
a function module managing unit comprising a service information exposure module to perform functions of the content aggregating unit, a service enabler module to perform functions of the content preparing unit, and a network abstraction module to perform functions of the content providing unit.

7. A data transmission device comprising:
a content aggregating unit to aggregate content associated with data from a content provider (CP);
a content preparing unit to prepare the aggregated content;
a content providing unit to provide the prepared content to a client; and
a function module managing unit to manage the content aggregating unit, the content preparing unit, and the content providing unit.

8. The device of claim 7, wherein the content aggregating unit aggregates content using a feed associated with metadata of the content.

9. The device of claim 7, wherein the function module managing unit comprises a service information exposure module to perform functions of the content aggregating unit, a service enabler module to perform functions of the content preparing unit, and a network abstraction module to perform functions of the content providing unit.

10. The device of claim 7, wherein the function module managing unit manages based on a capability for operation, administration, maintenance, and provisioning (OAM&P) including at least one of a capability for authentication, authorization and accounting (AAA), a capability for access control, a capability for policy enforcement, and a capability for monitoring.

11. A data transmission method implemented by a data transmission device comprising a content aggregating unit, a content preparing unit, and a content providing unit, the method comprising:
aggregating, by the content aggregating unit, content associated with data from a content provider (CP);
preparing, by the content preparing unit, the aggregated content; and
providing, by the content providing unit, the prepared content to a client.

12. The method of claim 11, wherein the aggregating comprises aggregating content using a feed associated with metadata of the content.

13. The method of claim 11, wherein the aggregating comprises aggregating content based on a key which has a right to update metadata of the content.

14. A data transmission method implemented by a data transmission device comprising a content provider (CP) registration unit, a content aggregating unit, a content preparing unit, and a content providing unit, and a function module managing unit, the method comprising:
managing, by the CP registration unit, a CP through registration;
aggregating, by the content aggregating unit, content associated with data from the CP;
preparing, by the content preparing unit, the aggregated content; and
providing, by the content providing unit, the prepared content to a client,
wherein the function module managing unit manages the content aggregating unit, the content preparing unit, and the content providing unit.

15. A data transmission method implemented by a data transmission device comprising a content aggregating unit, a content preparing unit, and a content providing unit, and a function module managing unit, the method comprising:
aggregating, by the content aggregating unit, content associated with data from a content provider (CP);
preparing, by the content preparing unit, the aggregated content; and
providing, by the content providing unit, the prepared content to a client,
wherein the function module managing unit manages the content aggregating unit, the content preparing unit, and the content providing unit.
